(19) United States
(12) Patent Application Publication
(10) Pub. No.: US 2023/0038630 A1
(43) Pub. Date: Feb. 9, 2023

(54) CONVERSION DEVICE, CONVERSION METHOD, AND CONVERSON PROGRAM

(71) Applicant: Nippon Telegraph and Telephone Corporation, Tokyo (JP)

(72) Inventors: Yuki MIYOSHI, Musashino-shi, Tokyo (JP); Hiroshi OSAWA, Musashino-shi, Tokyo (JP); Yuhei HAYASHI, Musashino-shi, Tokyo (JP); Chiharu MORIOKA, Musashino-shi, Tokyo (JP); Hiroki INOUE, Musashino-shi, Tokyo (JP); Takeaki NISHIOKA, Musashino-shi, Tokyo (JP)

(21) Appl. No.: 17/791,972

(22) PCT Filed: Jan. 24, 2020
(86) PCT No.: PCT/JP2020/002526

§ 371 Date: Jul. 11, 2022

(51) Int. Cl. H04L 45/74; H04L 43/022

(52) U.S. Cl. CPC H04L 45/74; H04L 43/022

(57) ABSTRACT

A conversion device (10) includes a separation unit (11) that separates an inputted encapsulated packet into flow information and sampled headers including outer headers and inner headers, a decapsulation unit (12) that separates the outer headers from the sampled headers, and a conversion unit (13) that obtains statistics about the inner headers on the basis of the sampled headers separated from the outer headers, generates an xFlow packet including at least statistical information indicating the statistics about the inner headers, and outputs the generated xFlow packet to an external device.

### TECHNICAL FIELD

The present invention relates to a conversion device, a conversion method, and a conversion program.

### BACKGROUND ART

To monitor a network and analyze traffic trends, there exists xFlow technology that performs packet sampling and calculates flow statistical information from the header information. Also, there exists xFlow technology that performs packet sampling and cuts out and forwards the header portion itself (header sample). Also, there exist technologies that interchangeably convert between the various existing xFlow formats.

### CITATION LIST

### Patent Literature

Patent Literature 1: Japanese Patent Laid-Open No. 2019-097069

### Non-Patent Literature

Non-Patent Literature 1: RFC 3954

Non-Patent Literature 2: RFC 5103

Non-Patent Literature 3: RFC 7011

Non-Patent Literature 4: RFC 7012

Non-Patent Literature 5: RFC 7013

Non-Patent Literature 6: RFC 7014

Non-Patent Literature 7: RFC 7015

Non-Patent Literature 8: “sFlow Version 5”, [retrieved Jan. 9, 2020], Internet <URL: https://sflow.org/sflow_version_5.txt>

Non-Patent Literature 9: RFC 7133

Non-Patent Literature 10: “pmcct”, [retrieved Jan. 9, 2020], Internet <URL: http://www.pmacct.net/>

Non-Patent Literature 11: “nProbe”, [retrieved Jan. 9, 2020], Internet <URL: https://www.ntop.org/products/netflow/nprobe/>

Non-Patent Literature 12: Yuhei HAYASHI, Hiroshi OSAWA, “Study of settings for inner-outer header mapping method using hashes”, IEICE Society Conference 2019, B-6-18

### SUMMARY OF THE INVENTION

### Technical Problem

A network (NW) device applying xFlow technology of the related art measures flow information internally, and outputs various flow information attached to an xFlow packet. However, with respect to encapsulated packets, NW devices of the related art can only measure the outer flow information of the packets. In other words, with respect to encapsulated packets, NW devices of the related art cannot measure the inner flow information of the packets. Additionally, with the xFlow format conversion methods of the related art, header sampling format conversion cannot be performed on the inner packets of an encapsulated packet.

Consequently, the xFlow technology of the related art has a problem of being incapable of outputting packets in the xFlow format necessary for aggregation and analysis of flow information for the inner packets of encapsulated packets.

The present invention has been devised in light of the above, and an objective is to provide a conversion device, a conversion method, and a conversion program capable of generating an xFlow packet suitable for aggregation and analysis of inner flow information of an encapsulated packet.

### Means for Solving the Problem

To address the problems described above and achieve the objective, a conversion device of the present invention includes a first separation unit that separates an inputted encapsulated packet into flow information and sampled headers including outer headers and inner headers, a second separation unit that separates the outer headers from the sampled headers, and a generation unit that obtains statistics about the inner headers on the basis of the sampled headers separated from the outer headers, and generates an xFlow packet including at least statistical information indicating the statistics about the inner headers.

Also, a conversion method of the present invention is a conversion method executed by a conversion device, and includes separating an inputted encapsulated packet into flow information and sampled headers including outer headers and inner headers, separating the outer headers from the sampled headers, and obtaining statistics about the inner headers on a basis of the sampled headers separated from the outer headers, and generating an xFlow packet including at least statistical information indicating the statistics about the inner headers.

Also, a conversion program of the present invention causes a computer to execute a process including separating an inputted encapsulated packet into flow information and sampled headers including outer headers and inner headers, separating the outer headers from the sampled headers, and obtaining statistics about the inner headers on a basis of the sampled headers separated from the outer headers, and generating an xFlow packet including at least statistical information indicating the statistics about the inner headers.

### Effects of the Invention

According to the present invention, xFlow packets in a format suitable for aggregation and analysis can be generated.

### BRIEF DESCRIPTION OF DRAWINGS

FIG. 1 is a block diagram illustrating an example of the configuration of a communication system according to an embodiment.

FIG. 2 is a block diagram illustrating an example of the configuration of the conversion device illustrated in FIG. 1.

FIG. 3 is a diagram for explaining the flow of processes in the conversion device illustrated in FIG. 2.

FIG. 4 is a diagram for explaining the flow of processes in the conversion device illustrated in FIG. 2.

FIG. 5 is a diagram for explaining processing by the storage unit illustrated in FIG. 2.

FIG. 6 is a diagram for explaining processing by the storage unit illustrated in FIG. 2.

FIG. 7 is a diagram for explaining processing by the conversion unit illustrated in FIG. 2.

FIG. 8 is a diagram for explaining a packet output process in the conversion device illustrated in FIG. 2.

FIG. 9 is a diagram for explaining a packet output process in the conversion device illustrated in FIG. 2.

FIG. 10 is a flowchart illustrating a processing procedure of a conversion process according to the embodiment.

FIG. 11 is a flowchart illustrating a processing procedure of the conversion process illustrated in FIG. 10.

FIG. 12 is a diagram for explaining an xFlow packet conversion process according to the related art.

FIG. 13 is a diagram for explaining an xFlow packet conversion process by the conversion device illustrated in FIG. 2.

FIG. 14 is a diagram illustrating an example of a computer with which a conversion device is achieved by executing a program.

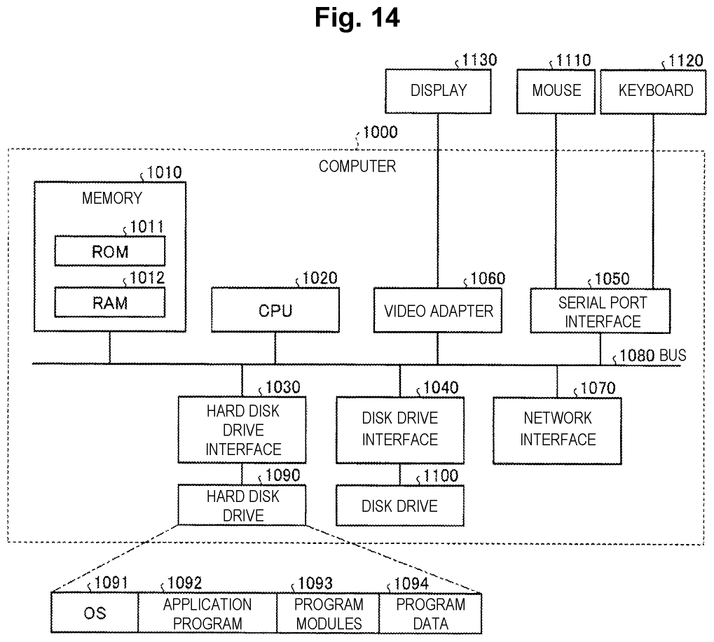

### DESCRIPTION OF EMBODIMENTS

Hereinafter, an embodiment of a conversion device, a conversion method, and a conversion program according to the present application will be described in detail on the basis of the drawings. Furthermore, the present invention is not limited by the embodiment described hereinafter.

[Embodiment]

First, the embodiment will be described. A conversion device according to the embodiment obtains statistics about the inner headers inside encapsulated packets inputted from each NW device, generates an xFlow packet including at least statistical information indicating the statistics about the inner headers, and outputs the generated xFlow packet to an external device that performs aggregation and analysis.

[Configuration of Communication System]

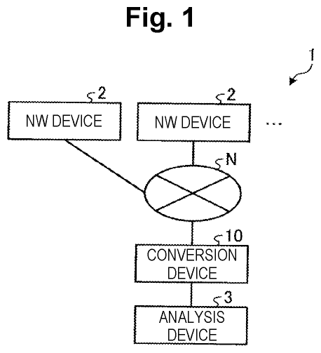

FIG. 1 is a block diagram illustrating an example of the configuration of a communication system according to the embodiment. As illustrated in FIG. 1, the communication system 1 according to the embodiment includes a plurality of NW devices 2, a conversion device 10, and an analysis device 3 (external device). For example, the plurality of NW devices 2 and the conversion device 10 communicate over a network N.

The NW devices 2 performs packet sampling in traffic to be monitored. For example, the NW devices 2 extract packet header samples from sampled packets and forward the extracted header samples encapsulated into an xFlow packet (encapsulated packet) to the conversion device 10. At this time, the NW devices 2 forward statistical information related to the flow of the number of packets and the like to the conversion device 10 by attaching the statistical information to the xFlow packet to be forwarded or transmitting the statistical information as a separate xFlow packet.

The conversion device 10 converts the xFlow packets inputted from the various NW devices 2 into xFlow packets in a format corresponding to the content of the processing performed by the external analysis device 3. Specifically, the conversion device 10 obtains statistics about the inner headers of the xFlow packets inputted from the various NW devices 2. Subsequently, the conversion device 10 generates an xFlow packet including at least statistical information indicating the obtained statistics about the inner headers, and outputs the generated xFlow packet to the external analysis device 3.

The analysis device 3 analyzes the traffic to be monitored and aggregates packets in the traffic to be monitored. The analysis device 3 performs analysis and aggregation by using the statistical information included in the xFlow packet converted by the conversion device 10.

[Conversion Device]

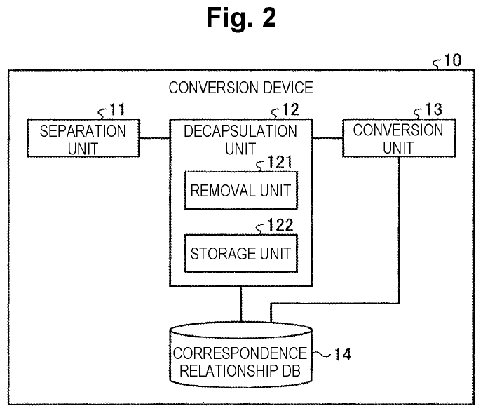

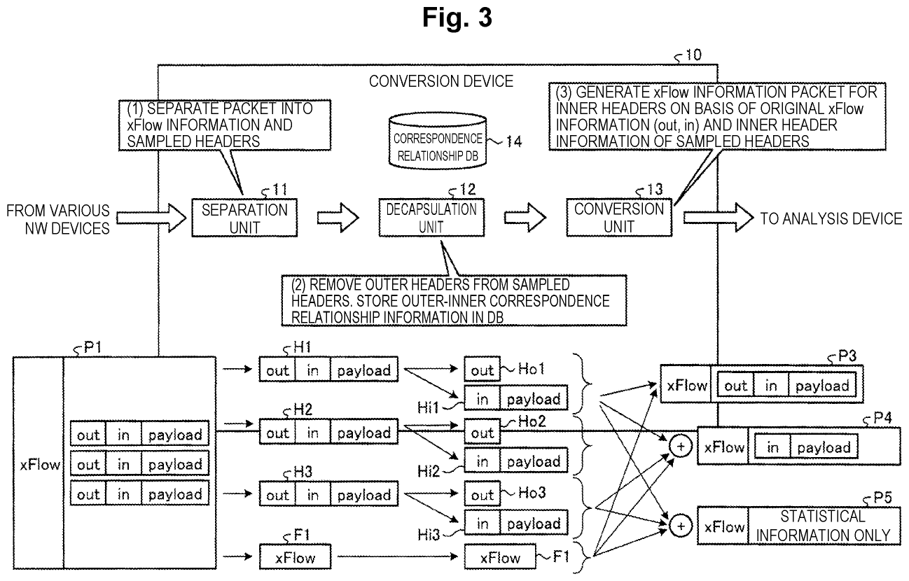

Next, the conversion device 10 will be described. FIG. 2 is a block diagram illustrating an example of the configuration of the conversion device 10 illustrated in FIG. 1. FIG. 3 is a diagram for explaining the flow of processes in the conversion device 10 illustrated in FIG. 2.

As illustrated in FIG. 2, the conversion device 10 includes a separation unit 11 (first separation unit), a decapsulation unit 12 (second separation unit), a conversion unit 13 (generation unit) and a correspondence relationship DB 14. Note that the conversion device 10 is achieved by loading a predetermined program into a device such as a computer including components such as read-only memory (ROM), random access memory (RAM), and a central processing unit (CPU), for example, and causing the CPU to execute the predetermined program. Also, the conversion device 10 includes a communication interface that transmits and receives various information with other devices connected through a network or the like. For example, the conversion device 10 includes a network interface card (NIC) or the like, and communicates with other devices through an electric communication channel such as a local area network (LAN) or the Internet.

The separation unit 11 separates an inputted xFlow packet into flow information and sampled headers including an outer header and an inner header. For example, the separation unit 11 separates an inputted xFlow packet P1 into xFlow information F1 and sampled headers H1 to H3 including an outer header and an inner header (see (1) in FIG. 3).

The decapsulation unit 12 separates the outer headers from the sampled headers. The sampled headers separated from the outer headers contain an inner header and a payload. The decapsulation unit 12 includes a removal unit 121 that removes the outer headers from the sampled headers and a storage unit 122 that stores information indicating correspondence relationships between the outer headers and the inner headers in the correspondence relationship DB 14. The decapsulation unit 12 respectively removes outer headers Ho1 to Ho3 from the sampled headers H1 to H3 (see (2) in FIG. 3), and acquires inner headers Hi1 to Hi3 and each piece of payload information. Additionally, the decapsulation unit 12 stores information indicating correspondence relationships between each of the outer headers Ho1 to Ho3 and each other of the inner headers Hi1 to Hi3 in the correspondence relationship DB 14 (see (2) in FIG. 3).

The conversion unit 13 obtains statistics about the inner headers on the basis of the sampled headers separated from the outer headers. The conversion unit 13 generates an xFlow packet including at least statistical information indicating the obtained statistics about the inner headers. The conversion unit 13 generates the xFlow packet in a format corresponding to the content of the processing performed by the analysis device 3 that acts as the output destination of the generated xFlow packet.

The conversion unit 13 generates an xFlow packet including statistical information about the inner headers on the basis of the original xFlow information (out, in) and the inner header information of the sampled headers (see (3) in FIG. 3).

At this point, the conversion unit 13 generates the xFlow packet in a format corresponding to the content of the processing performed by the analysis device 3. The format of the xFlow packet may be a format that includes only the statistical information (for example, the packet P5 in FIG. 3), a format that attaches an inner header sample to the statistical information (for example, the packet P4 in FIG. 3), or a format that attaches an inner header sample and an outer header sample to the statistical information (for example, the packet P3 in FIG. 3). The conversion unit 13 outputs the generated xFlow packet to the analysis device 3.

The correspondence relationship DB 14 stores correspondence relationships between the outer headers and the inner headers of the inputted xFlow packet. For example, in the correspondence relationship DB 14, time information is registered in association with the 5-tuple of the inner header and the 5-tuple of the outer header.

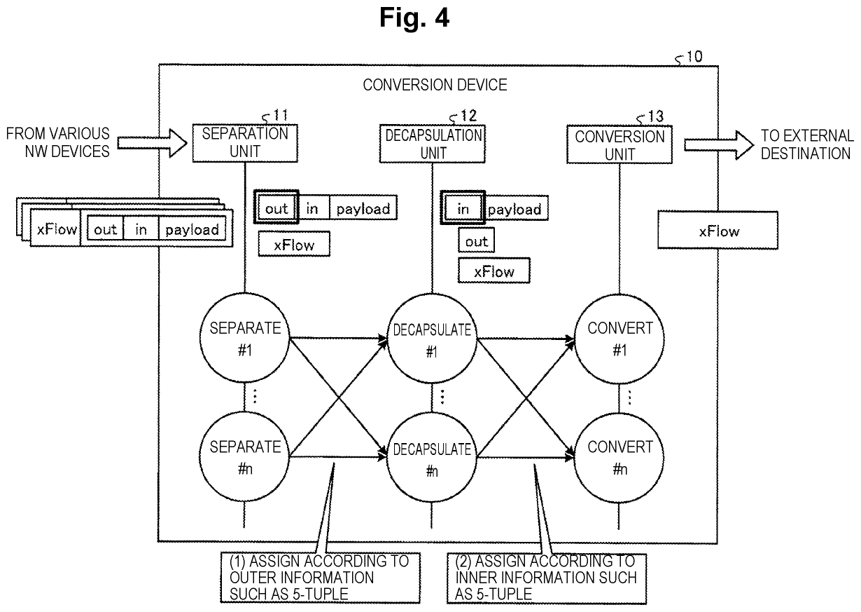

In the conversion device 10, the separation process by the separation unit 11, the separation process by the decapsulation unit 12, and the conversion process by the conversion unit 13 are executed in parallel on a plurality of xFlow packets. FIG. 4 will be referenced to described the parallel processing of a plurality of xFlow packets by the conversion device 10. FIG. 4 is a diagram for explaining the processing by the conversion device 10 illustrated in FIG. 2.

As illustrated in FIG. 4, the function of the separation unit 11, the function of the decapsulation unit 12, and the function of the conversion unit 13 are respectively deployed to a plurality of CPU cores in a distributed manner, thereby expanding each function of the conversion device 10.

Specifically, the function of the separation unit 11 is deployed to separation cores #1 to #n. The function of the decapsulation unit 12 is distributively deployed to decapsulation cores #1 to #n.

Sampled headers to be processed are assigned to the decapsulation cores #1 to #n according to outer information such as the 5-tuple. The sampled headers to be processed by the decapsulation core #1 all include an outer header “out 1”, while the sampled headers to be processed by the decapsulation core #n all include an outer header “out n”.

The function of the conversion unit 13 is distributively deployed to conversion cores #1 to #n. Inner headers to be processed are assigned to the conversion cores #1 to #n according to inner information such as the 5-tuple. The sampled headers separated from the outer headers to be processed by the conversion core #1 all include an inner header “in 1”, while the sampled headers separated from the outer headers to be processed by the conversion core #n all include an inner header “in n”.

In each of the separation cores #1 to #n, the separation unit 11 performs a process of separating an xFlow packet into xFlow information and sampled headers. Additionally, each of the separation cores #1 to #n uses outer information such as the 5-tuple in the sampled headers to assign each of the separated sampled headers to the decapsulation cores #1 to #n corresponding to the outer header information of each (see (1) in FIG. 4). In each of the decapsulation cores #1 to #n, the decapsulation unit 12 performs a process of separating the outer headers from the sampled headers. Additionally, each of the decapsulation cores #1 to #n uses inner information such as the 5-tuple in the sampled headers separated from the outer headers to assign each of the separated sampled headers to the conversion cores #1 to #n corresponding to the inner header information of each (see (2) in FIG. 4).

In each of the conversion cores #1 to #n, the conversion unit 13 obtains statistics about the inner header of each assigned sampled header, and generates an xFlow packet including at least the statistical information.

In this way, in the conversion device 10, sampled headers are assigned to each core with consideration for the ordering of the flow. Furthermore, in the conversion device 10, by respectively deploying the function of the separation unit 11, the function of the decapsulation unit 12, and the function of the conversion unit 13 to a plurality of CPU cores in a distributed manner, the separation processing by the separation unit 11, the separation processing by the decapsulation unit 12, and the generation processing by the conversion unit 13 are executed in parallel on a plurality of packets. With this arrangement, the processing by the conversion device 10 can be sped up.

[Removal Unit]

Next, the processing by the removal unit 121 illustrated in FIG. 2 will be described. The removal unit 121 analyzes a sampled header to determine the outer header position in the sampled header, and separates the outer header from the sampled header.

The removal unit 121 performs protocol stack analysis on a sampled header and specifies the outer header position in the sampled header. For example, the removal unit 121 may use the method described in Japanese Patent Laid-Open No. 2019-097069 to determine properties such as the header type and the outer header. The removal unit 121 determines a protocol stack pattern indicating the type and layout of each protocol header in the inputted sampled header according to determination rules. The protocol stack pattern is information indicating the type and layout of each protocol header.

Specifically, the removal unit 121 determines the protocol stack pattern of an inputted packet by using a determination tree for determining the protocol stack pattern created by successively inspecting packets with a known protocol stack pattern from the low-level header, a logical determination formula for determining the protocol stack pattern created on the basis of a specific bit sequence inside a packet with a known protocol stack pattern, or a protocol config file indicating standardized header information of each protocol. The determination rules may be pre-generated in another device or may be generated by performing training using protocol config files for inputted packets. Note that the removal unit 121 may also determine the header using another method.

[Storage Unit]

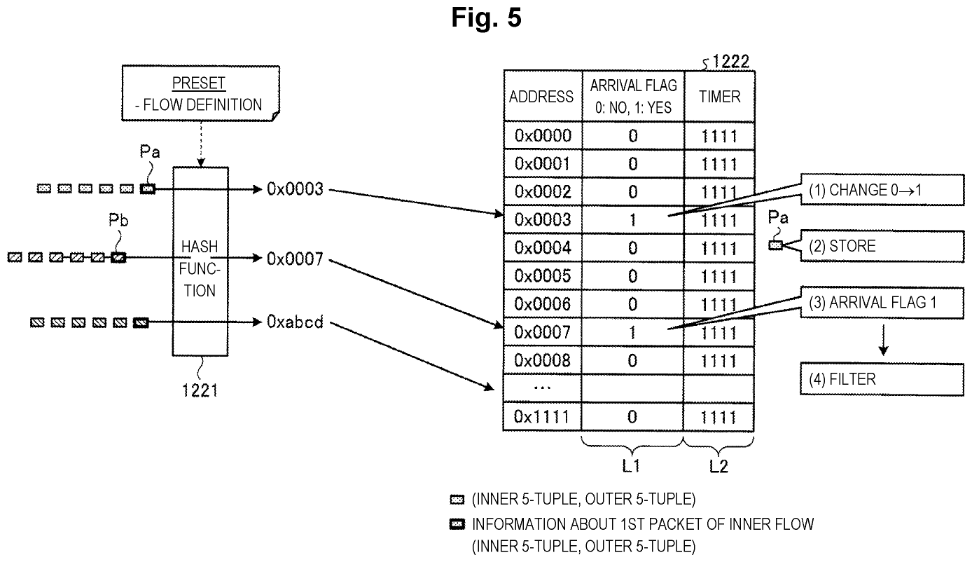

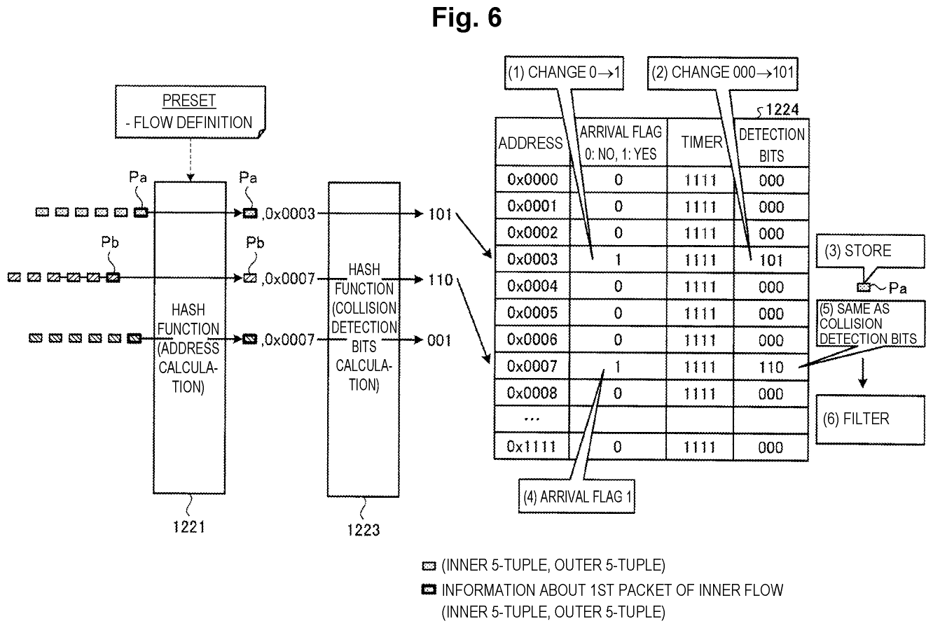

Next, the processing by the storage unit 122 illustrated in FIG. 2 will be described. The storage unit 122 selects a group of newly arrived flows from among the groups of inner headers and outer headers separated by the removal unit 121, and stores the group in the correspondence relationship DB 14. The storage unit 122 selects the initial xFlow packet in a sequential flow on the basis of a preset flow definition or flow duration distribution information obtained in advance, and stores the 5-tuple of the inner header and the 5-tuple of the outer header in the correspondence relationship DB 14. FIGS. 5 and 6 are diagrams for explaining processing by the storage unit 122 illustrated in FIG. 2.

For example, as illustrated in FIG. 5, the storage unit 122 selects the initial xFlow packet (1st packet) in a sequential flow by using a hash function unit 1222 that calculates a hash value on the basis of a preset flow definition and a hash table 1222.

The hash table 1222 includes fields for an address, an arrival flag indicating whether or not the 1st packet has arrived, and a timer. In the arrival flag, “0” indicates that the 1st packet has not yet arrived, and “1” indicates that the 1st packet has already arrived. The timer is a countdown timer used to perform a periodic entry refresh for reducing hash collisions. The default value of the arrival flag is “0”, and the default value of the timer is all “1”.

The hash function unit 1221 accepts a flow definition and 5-tuple information about the 5-tuple of the inner header and the 5-tuple of the outer header as input, and uses a hash function to calculate an information hash value concatenating the 5-tuple of the inner header and the 5-tuple of the outer header as an address. The storage unit 122 accesses the row of the hash table 1222 at the calculated address.

For example, with respect to a packet Pa, the storage unit 122 accesses the row of the calculated address “0x0003” in the hash table 1222. At this point, because the arrival flag is “0” in this row, the packet Pa is the initial packet of a sequential flow. The storage unit 122 changes the arrival flag from “0” to “1” in the row of the address “0x0003” (see (1) in FIG. 5), and stores the 5-tuples of the inner header and the outer header of the packet Pa in the correspondence relationship DB 14 (see (2) in FIG. 5).

Also, with respect to a packet Pb, the storage unit 122 accesses the row of the calculated address “0x0007” in the hash table 1222. At this point, the arrival flag is “1” in this row (see (3) in FIG. 5). Consequently, the storage unit 122 determines that the packet Pb is a packet in a flow for which the 1st packet has already arrived, and filters the information of the packet Pb (see (4) in FIG. 5).

At this point, the storage unit 122 refreshes the entries at a predetermined timing on the basis of a distribution of the flow duration to initialize old entries and reduce collisions.

For example, the storage unit 122 obtains the flow duration x (sec) corresponding to the a percentile (0≤α≤1) from the distribution of flow duration, and uses the flow duration x (sec) to set the refresh timing. Additionally, in the case where the timer bits are 1 or greater, the storage unit 122 sets the refresh interval to “x/(timer bits^2)”, and decrements the timer every refresh interval. Also, by changing the arrival flag from “1” to “0” for an entry whose timer bits are all “0” and also changing the timer to “1111”, the storage unit 122 refreshes the entry. Also, in the case where the timer bits are other than 1, the storage unit 122 sets the refresh interval to “x”, and every refresh interval, changes all of the arrival flags to “0” and also changes the timer to a default value to refresh the entry.

Also, instead of the arrival flag field L1 and the timer field L2 in the hash table 1222, a timeout time field may be provided, and in the case where a 1st packet arrives, the storage unit 122 may change a default value in the timeout time field to a timeout time, and refresh the entry when timeout is reached.

Also, as illustrated in FIG. 6, the storage unit 122 may also select the 1st packet by using a hash function unit 1221 for address calculation, a hash function unit 1223 for collision detection bit calculation, and a hash table 1224. The hash function unit 1223 accepts inner header information, outer header information, and an address as input, and uses a hash function to calculate collision detection bits. The hash table 1224 includes fields for an address, an arrival flag, a timer, and detection bits. The detection bits are used to detect hash collisions. The detection bits are all “0” as the default value.

For example, with respect to a packet Pa, the storage unit 122 accesses the row of the address “0x0003” in the hash table 1224. At this point, because the arrival flag is “0” in this row, the packet Pa is the initial packet of a sequential flow. The storage unit 122 changes the arrival flag from “0” to “1” in the row of the address “0x0003” (see (1) in FIG. 6), and changes the detection bits from the default value of “000” to the collision detection bits “101” calculated by the hash function unit 1223 (see (2) in FIG. 6). Additionally, the storage unit 122 stores the 5-tuples of the inner header and outer header of the packet Pa in the correspondence relationship DB 14 (see (3) in FIG. 6).

Also, with respect to a packet Pb, the storage unit 122 accesses the row of the address “0x0007” in the hash table 1224. At this point, the arrival flag in this row is “1” (see (4) in FIG. 6), and the detection bits “110” are the same value as the collision detection bits “110” of the packet Pb calculated in the hash function unit 1223 (see (5) in FIG. 6). Consequently, the storage unit 122 determines that the packet Pb is a packet in a flow for which the 1st packet has already arrived, and filters the information of the packet Pb (see (6) in FIG. 6).

Note that in the case where the arrival flag is “1” but the detection bits in the hash table 1244 do not match the calculated collision detection bits of the packet, the storage unit 122 detects a collision (hash collision), and may also sample the flow of the packet and store inner header information and outer header information. Also, the storage unit 122 refreshes the hash table 1224 using a method similar to the refresh method for the hash table 1222.

[Conversion Unit]

Next, the processing by the conversion unit 13 will be described. The conversion unit 13 obtains statistics about the inner headers on the basis of the sampled headers separated from the outer headers. In addition, the conversion unit 13 generates an xFlow packet in which statistical information indicating the obtained statistics about the inner headers is included in the xFlow information.

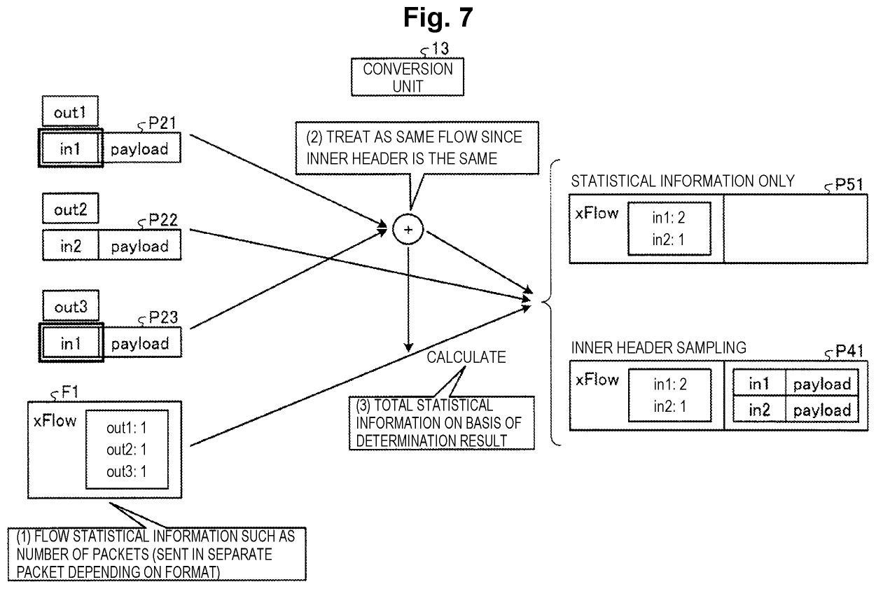

At this point, in the case of generating an xFlow packet in a format that includes only the statistical information or in a format that attaches an inner header sample to the statistical information, the conversion unit 13 totals the obtained statistical information about the inner headers and includes the totaled statistical information in the xFlow information. FIG. 7 is a diagram for explaining the processing by the conversion unit 13 illustrated in FIG. 2.

The xFlow information F1 illustrated in FIG. 7 is information that has been separated from an inputted xFlow packet by the separation unit 11 or transmitted as a separate packet. The xFlow information F1 includes flow statistical information such as the number of encapsulated packets. However, the xFlow information F1 only includes information about the outside of the xFlow packet, that is, statistical information about the outer headers (correspondence information between outer header identification information and the number of packets) (see (1) in FIG. 7).

At this point, in the conversion device 10, the outer headers are separated from the sampled headers by the decapsulation unit 12, and statistics about the inner headers of the sampled headers P21, P22, and P23 separated from the outer headers are obtained in the conversion unit 13.

For example, the conversion unit 13 obtains statistics indicating that the inner headers of the sampled packets P21 and P23 is “in 1”, and the inner header of the sampled header P22 is “in 2”. In this case, because the inner headers of the sampled headers P21 and P23 are the same, the conversion unit 13 treats the sampled headers P21 and P23 as the same flow (see (2) in FIG. 7). On the basis of this determination result, the conversion unit 13 totals statistical information regarding the inner header “in 1” of the sampled headers P21 and P23, and sets the number of packets with the inner header “in 1” to “2” (see (3) in FIG. 7).

The conversion unit 13 generates a packet P51 or a packet P41 in which inner header statistical information indicating that the number of packets with the inner header “in 1” is “2” and that the number of packets with the inner header “in 2” is “1” is included in the xFlow information.

In this way, the conversion unit 13 converts an encapsulated xFlow packet inputted into the conversion device 10 into an xFlow packet in which statistical information regarding the inner headers of the inner packets is included as flow information, and outputs the converted xFlow packet to the analysis device 3. As described in FIG. 7, the statistical information is aggregated information about each inner header of the inner packets encapsulated inside the xFlow packet, for example. As a result, the analysis device 3 receives the xFlow packet in which the statistical information regarding the inner headers of the inner packets is included in the flow information, and is capable of executing aggregation or analysis appropriately.

Next, a function of combining statistical information in the conversion unit 13 will be described. The conversion unit 13 generates and outputs a single xFlow packet in which statistical information about a plurality of packets is totaled. Here, the packets for which the statistical information is totaled are the inner packets encapsulated inside the xFlow packet.

For example, the conversion unit 13 includes a function of outputting a single xFlow packet in which statistical information about a plurality of packets in the same flow is combined. In other words, if a plurality of packets belong to the same flow, the conversion unit 13 combines statistical information about the packets and outputs a single xFlow packet. Namely, the conversion unit 13 totals statistical information regarding the inner headers of a plurality of packets having the same inner header, and generates a single xFlow packet including the totaled statistical information.

Additionally, a maximum inactive communication time (flow-inactive-timeout) and a maximum active communication time (flow-active-timeout) may be set with respect to the conversion device 10, and a packet output condition may be set using the set maximum inactive communication time and the maximum active communication time. For example, the output condition stipulates that there is a flow for which the maximum inactive communication time has elapsed since the time when a packet was last received, or that there is a flow for which the maximum active communication time has elapsed since the time when a packet was first received.

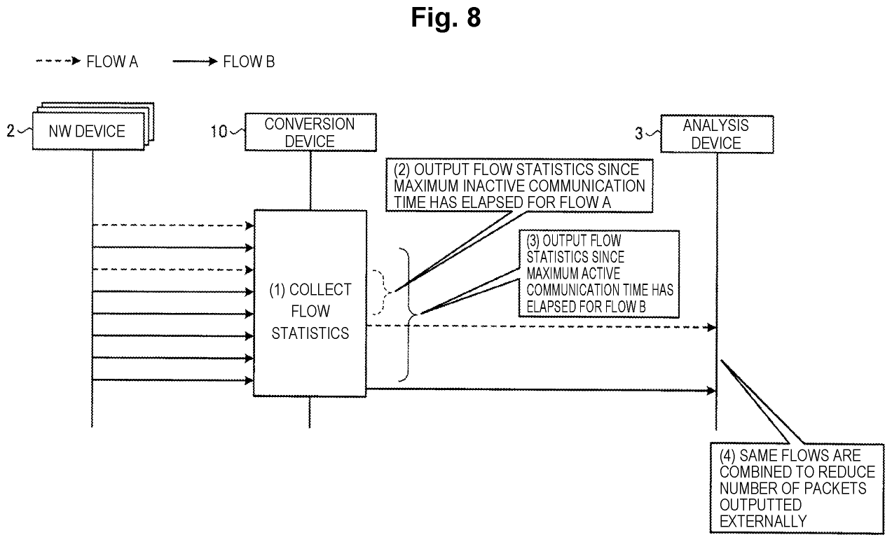

FIG. 8 is a diagram for explaining a packet output process by the conversion device 10 illustrated in FIG. 2. The conversion unit 13 collects flow statistical information, that is, statistical information about the inner header of each packet (see (1) in FIG. 8), while also determining whether or not a flow satisfying the output condition exists. For example, if a flow A is a flow for which the maximum inactive communication time has elapsed since the time when a packet was last received, the conversion unit 13 totals statistical information about the inner headers of the flow A, and outputs an xFlow packet including the totaled statistical information (see (2) in FIG. 8).

Also, if a flow B is a flow for which the maximum active communication time has elapsed since the time when a packet was first received, the conversion unit 13 totals statistical information about the inner headers of the flow B, and outputs an xFlow packet including the totaled statistical information (see (3) in FIG. 8).

In this way, because the conversion unit 13 totals statistical information about packets in the same flow and outputs xFlow information including the totaled statistical information, the number of packets outputted externally can be reduced (see (4) in FIG. 8). Note that the conversion unit 13 generates an xFlow packet by selecting one of a format that includes only the statistical information, a format that attaches an inner header sample to the statistical information, or a format that attaches an inner header sample and an outer header sample to the statistical information according to the content of the processing by the analysis device 3 acting as the output destination.

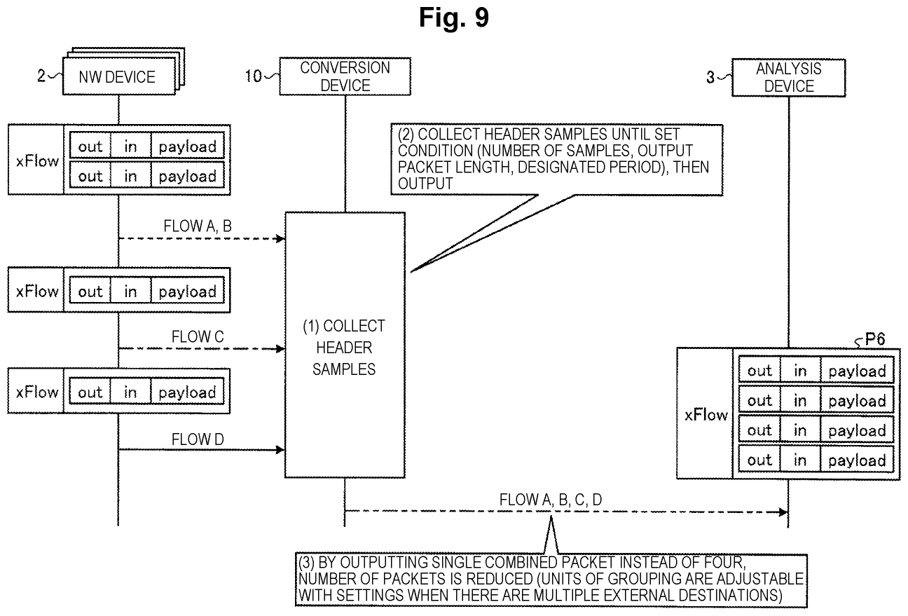

Additionally, the conversion unit 13 includes a function of outputting an xFlow packet with a plurality of header samples from different flows collectively attached, even if the headers are from different packets. FIG. 9 is a diagram for explaining a packet output process by the conversion device 10 illustrated in FIG. 2.

As illustrated in FIG. 9, packets in flows A to D are inputted into the conversion device 10 from various NW devices 2. In this case, the conversion unit 13 collects a header sample portion of each packet (see (1) in FIG. 9) while also determining whether or not a predetermined output condition is satisfied. For example, the predetermined output condition stipulates that a predetermined number of samples is reached, a predetermined output packet length is reached, or a designated time is reached.

The conversion unit 13 collects header sample portions without outputting flow information to the external analysis device 3 until the predetermined output condition is satisfied (see (2) in FIG. 9). Additionally, in the case of determining that the predetermined output condition is satisfied, the conversion unit 13 combines the collected header samples and outputs an information packet to the analysis device 3 (see (2) in FIG. 9). For example, the conversion unit 13 generates and outputs an xFlow packet P6 combining four header samples including the same inner headers. In this way, the conversion unit 13 can reduce the number of packets outputted externally by combining the information of four header sample portions into a single packet rather than four separate packets (see (3) in FIG. 9).

Also, FIG. 9 illustrates an example of combining an inner header sample and an outer header sample of four header sample portions into a single packet as the packet outputted by the conversion unit 13. The conversion unit 13 is not limited to a format that attaches an inner header sample and an outer header sample to the statistical information, and may also select a format that includes only statistical information or a format that attaches an inner header sample to the statistical information. For example, in the case where there is a plurality of external destinations, the conversion unit 13 generates an xFlow packet in a format set for each analysis device 3 according to the content of the processing by the analysis device 3 acting as the output destination. With this arrangement, the conversion unit 13 is capable of adjusting the units of combined information among statistical information only, statistical information and an inner header sample, or statistical information, an inner header sample, and an outer header sample according to the set format (see (3) in FIG. 9).

[Processing Procedure of Conversion Process]

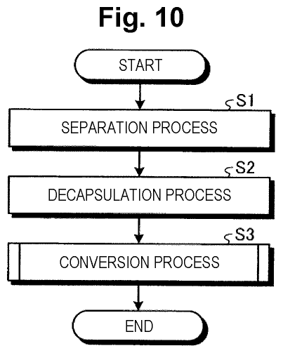

Next, a processing procedure of a packet conversion process executed by the conversion device 10 will be described. FIG. 10 is a flowchart illustrating the processing procedure of the conversion process according to the embodiment.

As illustrated in FIG. 10, in the conversion device 10, the separation unit 11 performs the separation process of separating an inputted xFlow packet into flow information and sampled headers (step S1). Subsequently, the decapsulation unit 12 performs the decapsulation process of separating the outer headers from the sampled headers (step S2). Note that in step S2, the decapsulation unit 12 separates the outer headers from the sampled headers, and also stores information indicating correspondence relationships between the outer headers and the inner headers in the correspondence relationship DB 14.

The conversion unit 13 performs the conversion process of obtaining statistics about the inner headers on the basis of the sampled headers separated from the outer headers, generating an xFlow packet including at least statistical information indicating the obtained statistics about the inner headers, and outputting the generated xFlow packet to the analysis device 3 (step S3).

[Processing Procedure of Conversion Process]

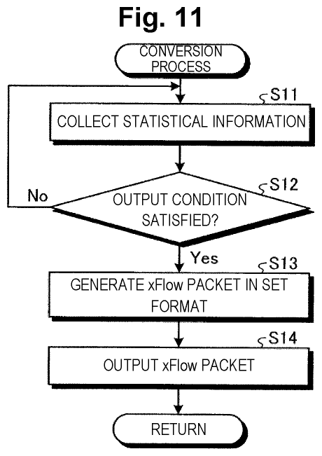

Next, a processing procedure of the conversion process (step S3) illustrated in FIG. 10 will be described. FIG. 11 is a flowchart illustrating a processing procedure of the conversion process illustrated in FIG. 10.

As illustrated in FIG. 11, the conversion unit 13 collects statistical information about the inner headers on the basis of the sampled headers which are separated from the outer headers and successively inputted from the decapsulation unit 12 (step S11). Additionally, the conversion unit 13 determines whether or not an xFlow packet output condition is satisfied (step S12). In the case where the xFlow packet output condition is not satisfied (step S12: No), the conversion unit 13 returns to step S11 and continues to collect statistical information about the inner headers.

In the case where the xFlow packet output condition is satisfied (step S12: Yes), the conversion unit 13 generates an xFlow packet in the set format (step S13). In this case, the conversion unit 13 includes statistical information indicating the obtained statistics about the inner headers in the xFlow information. Also, depending on the settings, the conversion unit 13 includes a totaled result of the statistical information about a plurality of packets in the same flow or a totaled result of the statistical information about a plurality of packets in different flows in the xFlow information. Subsequently, the conversion unit 13 outputs the generated xFlow packet to the external analysis device 3 (step S14).

[Effects of Embodiment]

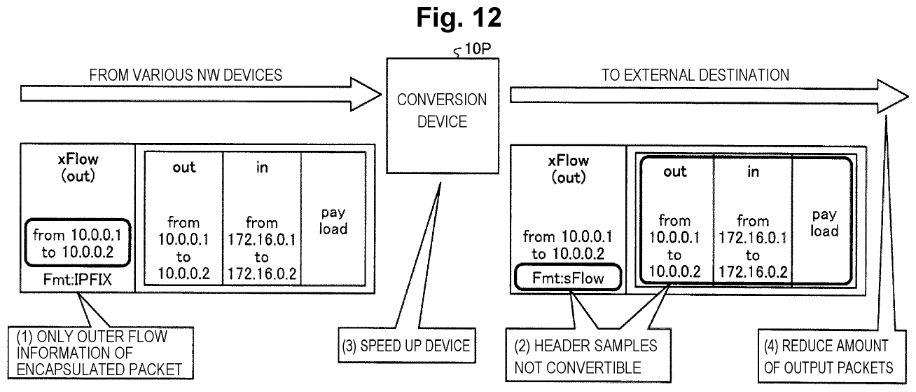

At this point, an xFlow packet conversion process according to the related art will be described. FIG. 12 is a diagram for explaining an xFlow packet conversion process according to the related art.

As an example, FIG. 12 illustrates a case in which an xFlow packet in the IPFIX format encapsulating packets from “172.16.0.1” to “172.16.0.2” (the subnet from 10.0.0.1 to 10.0.0.2) is converted to a packet in the sFlow format or the NetFlow format in a conversion device 10P.

As illustrated in FIG. 12, the information that is measurable by the conversion device 10P of the related art is only the outer flow information of the encapsulated packets (see (1) in FIG. 12). Consequently, with respect to encapsulated packets, the conversion device 10P of the related art cannot measure the inner flow information of the packets. Also, the conversion device 10P of the related art cannot convert the header sampling format of the inner packets of the encapsulated packet (see (2) in FIG. 12). Furthermore, in recent years, because increases in the traffic to be monitored have led to increases in device capacity and cost, there are also demands for a speedup in processing and a reduction in the amount of flow information packets outputted externally (see (3) and (4) in FIG. 12).

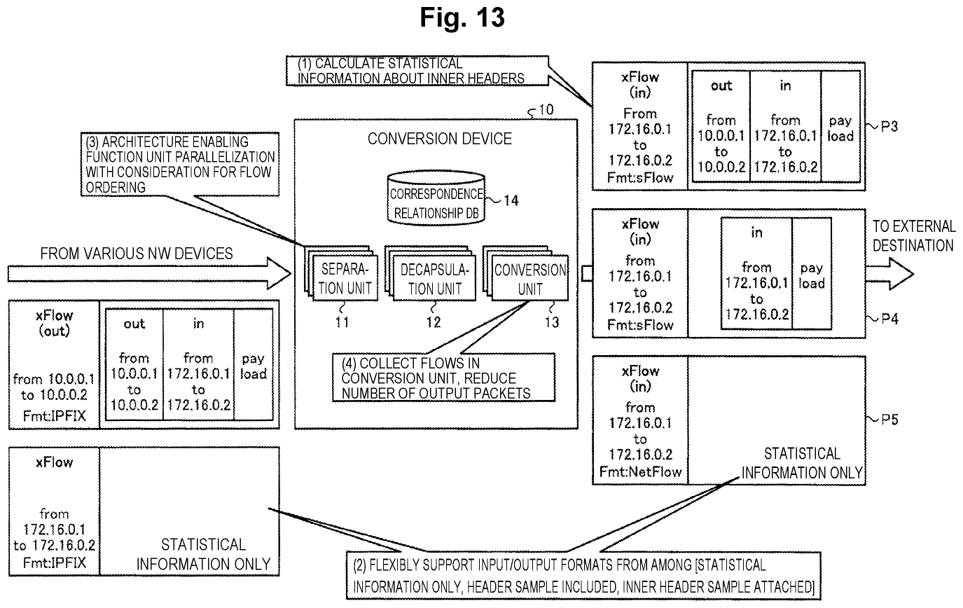

FIG. 13 is a diagram for explaining an xFlow packet conversion process by the conversion device 10 illustrated in FIG. 2. In the conversion device 10 according to the present embodiment, the separation unit 11 separates an inputted encapsulated packet into flow information and sampled headers, while the decapsulation unit 12 separates the outer headers from the sampled headers. The sampled headers separated from the outer headers contain an inner header and a payload. The conversion unit 13 obtains statistics about the inner headers on the basis of the sampled headers separated from the outer headers.

Consequently, according to the conversion device 10, it is possible to calculate statistical information about the inner part of an encapsulated packet, namely the inner headers, that could not be calculated in the related art (see (1) in FIG. 13).

Additionally, the conversion unit 13 generates an xFlow packet including at least statistical information indicating statistics about the inner headers. At this time, the conversion unit 13 generates the xFlow packet in a format corresponding to the content of the processing in the external device.

For example, the conversion unit 13 selects the format of the xFlow packet to be generated from among a format that includes only the statistical information (for example, the packet P5 in FIG. 13), a format that attaches an inner header sample to the statistical information (for example, the packet P4 in FIG. 13), or a format that attaches an inner header sample and an outer header sample to the statistical information (for example, the packet P3 in FIG. 13), according to the content of the processing by the external analysis device. In this way, because the conversion device 10 can set the xFlow format to be outputted flexibly according to the purpose of the aggregation or analysis in the analysis device 3, the aggregation or analysis can be executed appropriately in the analysis device 3.

Additionally, the conversion device 10 adopts an architecture enabling parallelization of the function units with consideration for the flow ordering (see (3) in FIG. 13). With this arrangement, in the conversion device 10, the separation process by the separation unit 11, the separation process by the decapsulation unit 12, and the conversion process by the conversion unit 13 can be executed in parallel on a plurality of xFlow packets, and therefore a speedup in processing can be achieved.

Furthermore, in the conversion device 10, the conversion unit 13 includes a function of generating and outputting a single xFlow packet in which statistical information about a plurality of packets is totaled. In this way, because the conversion device 10 aggregates flows in the conversion unit 13 to generate and output a single xFlow packet in which statistical information about a plurality of packets is totaled, the number of packets outputted externally can be reduced (see (4) in FIG. 13).

As above, according to the conversion device 10, an xFlow packet including statistical information about the inner flow information of an encapsulated packet can be generated, and furthermore, a speedup in performance of the device and a reduction in the number of packets outputted externally can be achieved.

[System Configuration of Embodiment]

Also, the structural elements of the conversion device 10 illustrated in FIG. 1 are functional and conceptual illustrations, and are not limited to being physically configured exactly as depicted in the drawings. In other words, the specific modes in which the functions of the conversion device 10 are separated or joined are not limited to the modes illustrated in the drawings, and all or part thereof may be functionally or physically separated or joined in any units according to factors such as various loads and usage conditions.

Also, all or any part of the processing performed in the conversion device 10 or 10B may be achieved by a CPU and a program that is interpreted and executed by the CPU. Moreover, the processing performed in the conversion device 10 may also be achieved as hardware through wired logic.

Additionally, it is also possible to perform manually all or part of the processes described as being performed automatically in the embodiment. Alternatively, it is possible to perform automatically, with known methods, all or part of the processes described as being performed manually. Otherwise, information including the processing sequences, control sequences, specific names, and various data or parameters described above and illustrated in the drawings may be modified appropriately except as noted.

[Program]

FIG. 12 is a diagram illustrating an example of a computer with which the conversion device 10 is achieved by executing a program. A computer 1000 includes a memory 1010 and a CPU 1020, for example. The computer 1000 also includes a hard disk drive interface 1030, a disk drive interface 1040, a serial port interface 1050, a video adapter 1060, and a network interface 1070. These components are connected by a bus 1080.

The memory 1010 includes ROM 1011 and RAM 1012. The ROM 1011 stores a boot program such as a basic input output system (BIOS), for example. The hard disk drive interface 1030 is connected to a hard disk drive 1090. The disk drive interface 1040 is connected to a disk drive 1100. A removable storage medium such as a magnetic disk or an optical disc is inserted into the disk drive 1100, for example. The serial port interface 1050 is connected to a mouse 1110 and a keyboard 1120, for example. The video adapter 1060 is connected to a display 1130, for example.

The hard disk drive 1090 stores an operating system (OS) 1091, an application program 1092, program modules 1093, and program data 1094, for example. Namely, a program prescribing each process of the conversion device 10 is implemented as a program module 1093 stated in code executable by the computer 1000. The program modules 1093 are stored in the hard disk drive 1090, for example. For example, program modules 1093 for executing processes similar to the functional configuration of the conversion device 10 are stored in the hard disk drive 1090. Note that the hard disk drive 1090 may also be replaced by a solid state drive (SSD).

In addition, setting data used in the processes of the embodiment described above is stored in the memory 1010 or the hard disk drive 1090 for example as the program data 1094. Moreover, the CPU 1020 reads out the program modules 1093 and the program data 1094 stored in the memory 1010 or the hard disk drive 1090 into the RAM 1012 as necessary, and executes them.

Note that the program modules 1093 and the program data 1094 are not limited to being stored in the hard disk drive 1090, and may also be stored in a removable storage medium and read out by the CPU 1020 through the disk drive 1100 or the like, for example. Alternatively, the program modules 1093 and the program data 1094 may be stored in another computer connected over a network (such as a local area network (LAN) or a wide area network (WAN)). In addition, the program modules 1093 and the program data 1094 may also be read out by the CPU 1020 from another computer through the network interface 1070.

The above describes an embodiment applying the invention made by the inventor, but the present invention is not limited by the description and drawings which form a part of the disclosure of the present invention according to the embodiment. In other words, other embodiments, examples, practical technologies, and the like made by persons skilled in the art on the basis of the present embodiment are all included in the scope of the present invention.

### REFERENCE SIGNS LIST

1 Communication system

2 NW device

3 Analysis device

10 Conversion device

11 Separation unit

12 Decapsulation unit

13 Conversion unit

14 Correspondence relationship database (DB)

121 Removal unit

122 Storage unit

1. A conversion device comprising:
a first separation unit, including one or more processors, configured to separate an inputted encapsulated packet into flow information and sampled headers including outer headers and inner headers;
a second separation unit, including one or more processors, configured to separate the outer headers from the sampled headers; and
a generation unit, including one or more processors, configured to obtain statistics about the inner headers on a basis of the sampled headers separated from the outer headers, and generate an xFlow packet including at least statistical information indicating the statistics about the inner headers.

2. The conversion device according to claim 1, wherein the generation unit is configured to generate the xFlow packet in a format corresponding to a content of a processing in an output destination of the generated xFlow packet.

3. The conversion device according to claim 2, wherein the generation unit is configured to generate the xFlow packet in a format that includes only the statistical information, a format that attaches an inner header sample to the statistical information, or a format that attaches an inner header sample and an outer header sample to the statistical information.

4. The conversion device according to claim 3, wherein
a function of the first separation unit, a function of the second separation unit, and a function of the generation unit are distributively deployed to respective pluralities of CPU cores,
in each core, the first separation unit is configured to perform a process of separating the xFlow packet into flow information and sampled headers, and assign the sampled headers to cores of the second separation unit corresponding to outer header information of the separated sampled headers,
in each core, the second separation unit is configured to perform a process of separating outer headers from the sampled headers, and assign the sampled headers separated from the outer headers to cores of the generation unit corresponding to inner header information of the sampled headers separated from the outer headers,
in each core, the generation unit is configured to obtain statistics about the inner header of an assigned sampled header, and generate an xFlow packet including at least the statistical information, and
the separation process by the first separation unit, the separation process by the second separation unit, and the generation by the generation unit are executed in parallel on a plurality of packets.

5. The conversion device according to claim 4, wherein
the generation unit is configured to generate an xFlow packet in which the statistical information about a plurality of packets is totaled.

6. A conversion method executed by a conversion device, the conversion method comprising:
separating an inputted encapsulated packet into flow information and sampled headers including outer headers and inner headers;
separating the outer headers from the sampled headers; and
obtaining statistics about the inner headers on a basis of the sampled headers separated from the outer headers, and generating an xFlow packet including at least statistical information indicating the statistics about the inner headers.

7. A non-transitory computer-readable medium storing one or more instructions causing a computer to execute:
separating an inputted encapsulated packet into flow information and sampled headers including outer headers and inner headers;
separating the outer headers from the sampled headers; and
obtaining statistics about the inner headers on a basis of the sampled headers separated from the outer headers, and generating an xFlow packet including at least statistical information indicating the statistics about the inner headers.

8. The conversion method according to claim 6, further comprising:
generating the xFlow packet in a format corresponding to a content of a processing in an output destination of the generated xFlow packet.

9. The conversion method according to claim 8, further comprising:
generating the xFlow packet in a format that includes only the statistical information, a format that attaches an inner header sample to the statistical information, or a format that attaches an inner header sample and an outer header sample to the statistical information.

10. The conversion method according to claim 9, further comprising:
deploying, distributively, a first function, a second function, and a third function to respective plurality of CPU cores;
performing, in each core, a first process of separating the xFlow packet into flow information and sampled headers, and assigning the sampled headers to cores of a second separation unit corresponding to outer header information of the separated sampled headers;
performing, in each core, a second process of separating outer headers from the sampled headers, and assigning the sampled headers separated from the outer headers to cores of a generation unit corresponding to inner header information of the sampled headers separated from the outer headers;
obtaining, in each core, statistics about the inner header of an assigned sampled header, and generating an xFlow packet including at least the statistical information; and
executing the first process, the second process, and the obtaining statistics in parallel on a plurality of packets.

11. The conversion method according to claim 10, further comprising:
generating an xFlow packet in which the statistical information about a plurality of packets is totaled.

12. The non-transitory computer readable medium according to claim 7, further comprising:
generating the xFlow packet in a format corresponding to a content of a processing in an output destination of the generated xFlow packet.

13. The non-transitory computer readable medium according to claim 12, further comprising:
generating the xFlow packet in a format that includes only the statistical information, a format that attaches an inner header sample to the statistical information, or a format that attaches an inner header sample and an outer header sample to the statistical information.

14. The non-transitory computer readable medium according to claim 13, further comprising:
deploying, distributively, a first function, a second function, and a third function to respective plurality of CPU cores;
performing, in each core, a first process of separating the xFlow packet into flow information and sampled headers, and assigning the sampled headers to cores of a second separation unit corresponding to outer header information of the separated sampled headers;
performing, in each core, a second process of separating outer headers from the sampled headers, and assigning the sampled headers separated from the outer headers to cores of a generation unit corresponding to inner header information of the sampled headers separated from the outer headers;
obtaining, in each core, statistics about the inner header of an assigned sampled header, and generating an xFlow packet including at least the statistical information; and
executing the first process, the second process, and the obtaining statistics in parallel on a plurality of packets.

15. The non-transitory computer readable medium according to claim 14, further comprising:
generating an xFlow packet in which the statistical information about a plurality of packets is totaled.
